(19) United States
(12) Patent Application Publication
(10) Pub. No.: US 2017/0320659 A1
(43) Pub. Date: Nov. 9, 2017

(54) OH Cup - A device for facilitating the production of an instant alcoholic beverage

(71) Applicant: David Greer, Oakland, CA (US)

(72) Inventor: David Greer, Oakland, CA (US)

(21) Appl. No.: 15/148,022

(22) Filed: May 6, 2016

(51) Int. Cl. B65D 85/804; C12G 3/04

(52) U.S. Cl. CPC B65D 85/8046; B65D 85/8043; C12G 3/04

(57) ABSTRACT

The OH Cup is a mechanism by which the average person can make an instant, single or multi-serve alcoholic beverage, on demand by simply adding water, either carbonated or still.

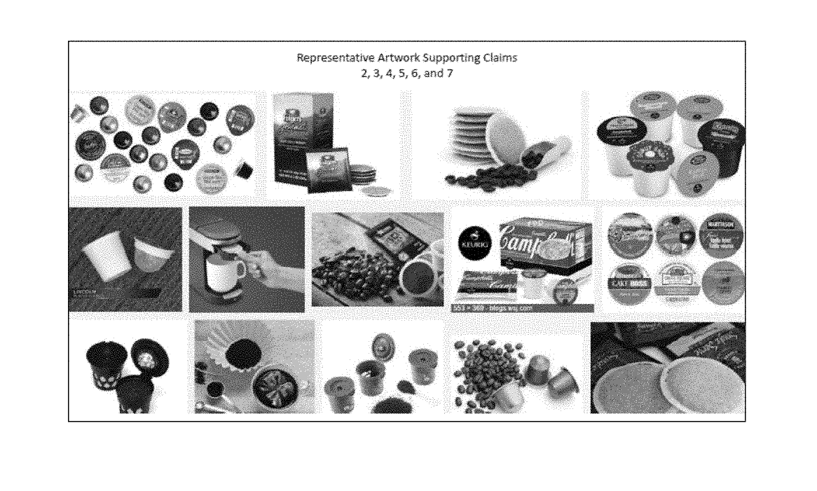

### Technical Field and Industrial Applicability of the Invention

### Food and Beverage Production—Instant Single Serve Alcoholic Beverage

This invention relates to the production of Instant Single Serve and Multi Serve Alcoholic Beverages

### BACKGROUND OF THE INVENTION

Many adults enjoy drinking alcoholic beverages.

Not all adults have the skills to make the alcoholic beverage of their choice.

Not all adults want to take the time to prepare an alcoholic beverage.

The proper ingredients are not always at hand.

An attractive alternative to hand crafting an alcoholic beverage would be to use a pre-packaged base material wherein you would just have to add water, either still or carbonated to make an instant single serve or multi serve alcoholic beverage.

As an example, this model is in widespread use in the single serve coffee brewing market.

What is claimed:

1. A package for containing a base material from which could be made an alcoholic beverage by simply adding still or carbonated water.
1.1. This method of claim one is that the package may be made from: metal, plastic, paper, or other material, or any combination thereof.
1.2. This method of claim one is that the package may be made of materials that are: impermeable, semi-permeable, or permeable, or any combination thereof.
1.3. This method of claim one is that the package may be: single-use or multi-use.
1.4. This method of claim one is that the package may be: pre-filled, fillable, or re-fillable.
1.5. This method of claim one is that the package may be: rigid, semi-rigid, or flexible, or any combination thereof.
1.6. This method of claim one is that the package may take the form of a: cup, pod, packet, capsule, or other form factor compatible with current or future single serve brewing systems, whether such systems are intended for coffee or other beverages.
1.7. This method of claim one is that the contents of the package are a combination of powdered, concentrated or regular strength: alcohol; colorants; flavorings; and organics; or a combination thereof in any desired proportion.

2. (canceled)

3. (canceled)

4. (canceled)

5. (canceled)

6. (canceled)

7. (canceled)

8. (canceled)
